(19) United States
(12) Patent Application Publication
(10) Pub. No.: US 2007/0236628 A1
(43) Pub. Date: Oct. 11, 2007

(54) Illumination Light Unit and Optical System Using Same

(75) Inventor: Kenneth A. Epstein, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/278,206

(22) Filed: Mar. 31, 2006

(51) Int. Cl. G02F 1/1335

(52) U.S. Cl. 349/67

(57) ABSTRACT

The present disclosure provides an illumination light unit including an array of LEDs disposed on a substrate, a controlled transmission mirror positioned to receive illumination light from the array of LEDs, and a reflector sheet positioned between the substrate and the controlled transmission mirror. The reflector sheet includes an array of reflectors each having an aperture. Respective LEDs of the array of LEDs protrude through respective apertures of the reflectors. Each reflector is operable to direct at least a portion of illumination light from its respective LED to the controlled transmission mirror.

### BACKGROUND

Liquid crystal displays (LCDs) are optical displays used in devices such as laptop computers, hand-held calculators, digital watches, and televisions. Some LCDs, for example, in laptop computers, cell phones, and certain LCD monitors and LCD televisions (LCD-TVs), are illuminated from behind using a backlight that has a number of light sources positioned to the side of the display panel. The light is guided from the light sources using a light guide that is positioned behind the display. The light guide is typically configured to extract the light from the light guide and to direct the light towards the display panel. This arrangement is commonly referred to as an edge-lit display, and is often used in applications where the display is not too large and/or the displayed image does not have to be very bright. For example, most computer monitors are viewed from a close distance, and so do not have to be as bright as an equivalently sized television display, which is typically viewed from a greater distance.

In larger, or brighter displays, the backlight tends to employ light sources positioned directly behind the display panel. One reason for this is that the light power requirements to achieve a certain level of display brightness increase with the square of the display size. Since the available real estate for locating light sources along the side of the display only increases linearly with display size, there comes a point where the light sources have to be placed behind the panel rather than to the side to achieve the desired level of brightness.

One important aspect of a backlight is that the light illuminating the display panel should be uniformly bright. Illuminance uniformity is particularly a problem when using point sources, for example, light emitting diodes (LEDs). In such cases, the backlight is required to spread the light across the display panel so that the displayed image has no dark areas. In addition, in some applications, the display panel is illuminated with light from a number of different LEDs that produce light of different colors. It is important in these situations that the light from the different LEDs be mixed so that the color, as well as the brightness, are uniform across the displayed image.

### SUMMARY

In aspect, the present disclosure provides an illumination light unit that includes an array of LEDs disposed on a substrate, where each LED of the array of LEDs is capable of generating illumination light. The unit further includes a controlled transmission mirror positioned to receive illumination light from the array of LEDs, where the controlled transmission mirror includes an input coupling element, an output coupling element, and a first multilayer reflector disposed between the input and output coupling elements, where the input coupling element redirects at least some of the illumination light incident thereon in a direction substantially perpendicular to the first multilayer reflector into a direction that is transmitted through the first multilayer reflector to the output coupling element. The unit further includes a reflector sheet positioned between the substrate and the controlled transmission mirror, where the reflector sheet includes an array of reflectors each having an aperture, where respective LEDs of the array of LEDs protrude through respective apertures of the reflectors, where each reflector is operable to direct at least a portion of illumination light from its respective LED to the controlled transmission mirror.

In another aspect, the present disclosure provides an optical system that includes an image-forming panel having an illumination side and a viewing side, and an illumination light unit positioned adjacent the illumination side of the image-forming panel. The illumination light unit includes an array of LEDs disposed on a substrate, where each LED of the array of LEDs is capable of generating illumination light. The unit further includes a controlled transmission mirror positioned to receive illumination light from the array of LEDs, where the controlled transmission mirror includes an input coupling element, an output coupling element, and a first multilayer reflector disposed between the input and output coupling elements, where the input coupling element redirects at least some of the illumination light incident thereon in a direction substantially perpendicular to the first multilayer reflector into a direction that is transmitted through the first multilayer reflector to the output coupling element. The unit further includes a reflector sheet positioned between the substrate and the controlled transmission mirror, where the reflector sheet includes an array of reflectors each having an aperture, where respective LEDs of the array of LEDs protrude through respective apertures of the reflectors, where each reflector is operable to direct at least a portion of illumination light from its respective LED to the controlled transmission mirror.

The above summary of the present disclosure is not intended to describe each illustrated embodiment or every implementation of the present disclosure. The figures and the following detailed description more particularly exemplify these embodiments.

### BRIEF DESCRIPTION OF THE DRAWINGS

FIG. 1 schematically illustrates one embodiment of an optical system.

FIGS. 2A and 2B schematically illustrate an embodiment of an illumination light unit that includes a controlled transmission mirror.

FIG. 3 schematically illustrates one embodiment of a reflector sheet for an illumination light unit.

FIGS. 4A-4D schematically illustrate cross-sectional views of different embodiments of controlled transmission mirrors that include various input coupling elements.

FIGS. 5A-5D schematically illustrate cross-sectional views of different embodiments of controlled transmission mirrors that include various output coupling elements.

FIG. 6A schematically illustrates a cross-sectional view of an embodiment of a polarization sensitive controlled transmission mirror.

FIGS. 6B and 6C schematically illustrate different embodiments of polarization-sensitive output coupling elements that can be used with the polarization sensitive controlled transmission mirror of FIG. 6A.

### DETAILED DESCRIPTION

In general, the present disclosure provides various embodiments of illumination light units that include one or more controlled transmission mirrors. Such mirrors can redirect at least some of the illumination light incident thereon from one or more light sources in a direction substantially perpendicular to the controlled transmission mirror into a non-perpendicular direction that is transmitted through the controlled transmission mirror. By redirecting light from a light source that is incident thereon in a substantially perpendicular direction, the controlled transmission mirrors of the present disclosure can provide more uniform brightness from the illumination light unit to a display, sign, or other suitable device.

Further, some embodiments of controlled transmission mirrors of the present disclosure can also provide greater color uniformity to a display from light sources that produce different wavelengths of light. For example, an illumination light unit may include a first light source capable of producing light of a first wavelength, and a second light source capable of producing light of a second wavelength. The combination of the first and second wavelengths can provide white light. A controlled transmission mirror can mix the first and second wavelengths of light by reflecting a substantial portion of the incident light back to be reflected by a reflective substrate or reflector. Such multiple reflections can cause better distribution of the first and second wavelengths of light in the output of the illumination light unit, thereby providing greater color uniformity.

In typical illumination light units that utilize point sources, light from one light source may be permitted to pass to an adjacent light source. However, in some applications, such as an information display or sign, it may be desirable to prevent light from passing between adjacent light sources. One approach to reduce such cross-talk between adjacent light sources is to ensure that all of the light from a light source is directed out of the illumination light unit before the light reaches another light source in the unit. Further, in some embodiments, it may be desirable to provide an illumination light unit for a display that can provide separate zones or regions that can be controlled such that the display provides greater contrast to a viewer.

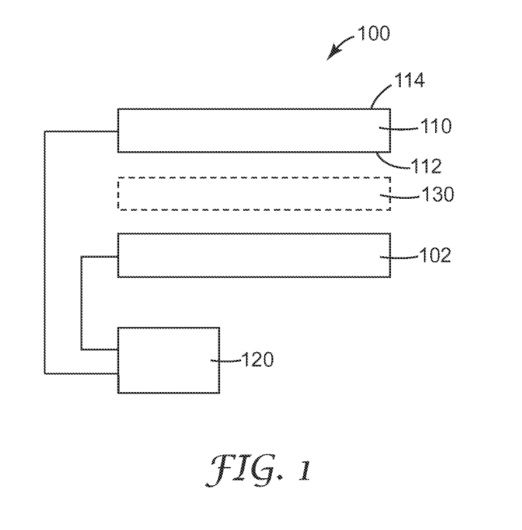

FIG. 1 schematically illustrates one embodiment of an optical system 100. The system 100 includes an image-forming panel 110 having an illumination side 112 and a viewing side 114, and an illumination light unit 102 positioned on the illumination side 112 of the image-forming panel 110.

The image-forming panel 110 may include any suitable device that can provide an image using illumination light from the illumination light unit 102. Typically, an image-forming panel includes one or more individually addressable controllable elements that control the transmission of light through the image-forming panel. In some embodiments, the image-forming panel 110 may include an LC panel that typically includes a layer of LC disposed between panel plates. The plates are often formed of glass that can include electrode structures and alignment layers on their inner surfaces for controlling the orientation of the liquid crystals in the LC layer. The electrode structures are commonly arranged so as to define LC panel pixels, i.e., areas of the LC layer where the orientation of the liquid crystals can be controlled independently of adjacent pixels. Color filters may also be included with one or more of the plates for imposing color on the displayed image.

The LC panel may also include other suitable layers or optical elements for providing an image. For example, the LC panel can include an upper absorbing polarizer positioned above the LC layer and a lower absorbing polarizer positioned below the LC layer. The absorbing polarizers and the LC panel, in combination, control the transmission of light from the illumination light unit 102 through the image-forming panel 110 to the viewer. When a pixel of the LC layer is not activated, it does not change the polarization of light passing therethrough. Accordingly, light that passes through the lower absorbing polarizer is absorbed by the upper absorbing polarizer when the absorbing polarizers are aligned perpendicularly. When the pixel is activated, on the other hand, the polarization of the light passing therethrough is rotated so that at least some of the light that is transmitted through the lower absorbing polarizer is also transmitted through the upper absorbing polarizer. Selective activation of the different pixels of the LC layer, for example, by a controller 120 coupled to the image-forming panel 110, results in the light passing out of the system 100 at certain desired locations, thus forming an image seen by the viewer. The controller 120 may include, for example, a computer or a television controller that receives and displays television images. In some embodiments, the controller 120 can also be coupled to the illumination light unit 102 to deliver image data to the illumination light unit 102 as is further described herein.

The image-forming panel 110 can also include one or more optional layers adjacent the viewing side 114, for example, to provide mechanical and/or environmental protection to the display surface. In one exemplary embodiment, such layers may include a hardcoat.

Some types of LC displays may operate in a manner different from that described herein and, therefore, differ in detail from the described system. For example, the absorbing polarizers may be aligned parallel and the LC panel may rotate the polarization of the light when in an unactivated state. Regardless, the basic structure of such displays remains similar to that described herein.

In some embodiments, an arrangement of light management layers 130 may be positioned between the illumination light unit 102 and the LC panel 110. The light management layers 130 affect the light propagating from the illumination light unit 102 so as to improve the operation of the optical system 100. For example, the light management layers 130 may include a reflective polarizer. This is useful because the illumination light unit 102 may typically include light sources that produce unpolarized light, whereas a lower absorbing polarizer of the image-forming panel 110 only transmits a single polarization state. Thus, about half of the light generated by the light sources is not suitable for transmission through to the LC layer of the image-forming panel 110. The reflecting polarizer, however, may be used to reflect the light that would otherwise be absorbed in the lower absorbing polarizer, and so this light may be recycled by reflection between the reflecting polarizer and the illumination light unit 102. Any suitable type of reflective polarizer may be used, e.g., multilayer optical film (MOF) reflective polarizers, diffusely reflective polarizing film (DRPF), such as continuous/disperse phase polarizers, wire grid reflective polarizers, or cholesteric reflective polarizers.

Both the MOF and continuous/disperse phase reflective polarizers rely on the difference in refractive index between at least two materials, usually polymeric materials, to selectively reflect light of one polarization state while transmitting light in an orthogonal polarization state. Some examples of MOF reflective polarizers are described in co-owned U.S. Pat. No. 5,882,774 (Jonza et al.). Commercially available examples of MOF reflective polarizers include Vikuiti™ DBEF-D200 and DBEF-D400 multilayer reflective polarizers that include diffusive surfaces, available from 3M Company, St. Paul, Minn.

Examples of DRPF useful in connection with the present disclosure include continuous/disperse phase reflective polarizers as described in co-owned U.S. Pat. No. 5,825,543 (Ouderkirk et al.), and diffusely reflecting multilayer polarizers as described in co-owned U.S. Pat. No. 5,867,316 (Allen et al.). Other suitable types of DRPF are described in U.S. Pat. No. 5,751,388 (Larson).

Some examples of wire grid polarizers useful in connection with the present disclosure include those described in U.S. Pat. No. 6,122,103 (Perkins et al.). Wire grid polarizers are commercially available from, inter alia, Moxtek Inc., Orem, Utah.

Some examples of cholesteric polarizers useful in connection with the present disclosure include those described, e.g., in U.S. Pat. No. 5,793,456 (Broer et al.), and U.S. Patent Publication No. 2002/0159019 (Pokomy et al.). Cholesteric polarizers are often provided along with a quarter wave retarding layer on the output side so that the light transmitted through the cholesteric polarizer is converted to linear polarization.

A polarization mixing layer may be placed between the illumination light unit 102 and the reflecting polarizer to aid in mixing the polarization of the light reflected by the reflecting polarizer. For example, the polarization mixing layer may be a birefringent layer such as a quarter-wave retarding layer.

The light management layers 130 may also include one or more brightness enhancing layers. A brightness enhancing layer is one that includes a surface structure that redirects off-axis light into a propagation direction closer to the axis of the display. This controls the viewing angle of the illumination light passing through the image-forming panel 110, typically increasing the amount of light propagating on-axis through the image-forming panel 110. Consequently, the on-axis brightness of the image seen by the viewer is increased.

One example of a brightness enhancing layer has a number of prismatic ridges that redirect the illumination light through a combination of refraction and reflection. Examples of prismatic brightness enhancing layers that may be used in the optical system 100 include the Vikuiti™ BEFII and BEFIII family of prismatic films available from 3M Company, St. Paul, Minn., including BEFII 90/24, BEFII 90/50, BEFIIIM 90/50, and BEFIIIT. Although only one brightness enhancing layer may be used, a common approach is to use two brightness enhancing layers, with their structures oriented at about 90° to each other. This crossed configuration provides control of the viewing angle of the illumination light in two dimensions, i.e., the horizontal and vertical viewing angles.

Positioned adjacent the illumination side 112 of the image-forming panel is the illumination light unit 102. In general, the illumination light unit 102 generates illumination light and directs such light to the illumination side 112 of the image-forming panel 110. The illumination light unit 102 can include any suitable light source or sources (not shown) for generating illumination light. In some embodiments, the light sources may be linear sources, such as cold cathode, fluorescent tubes. In other embodiments, other types of light sources may also be used, such as filament or arc lamps, light emitting diodes (LEDs), organic LEDs (OLEDs), flat fluorescent panels, or external fluorescent lamps. This list of light sources is not intended to be limiting or exhaustive but only exemplary.

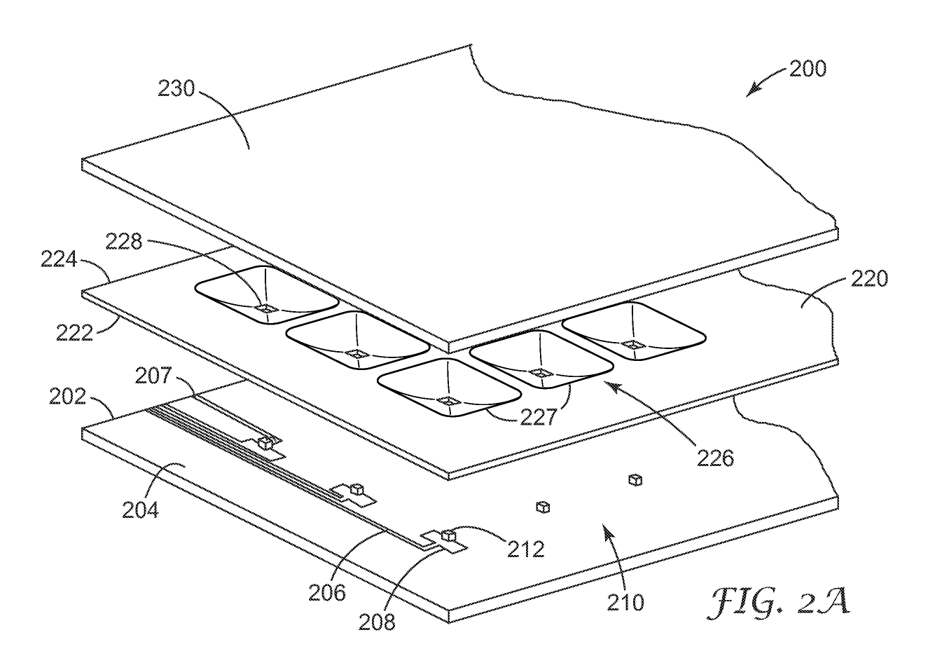

One exemplary embodiment of an illumination light unit 200 is illustrated in FIGS. 2A-B. Illumination light unit 200 includes an array of LEDs 210 disposed on a substrate 202. The unit 200 also includes a reflective sheet 220 that includes an array of reflectors 226 disposed with the array of LEDs 210, and a controlled transmission mirror 230 positioned such that the reflective sheet 220 is between the controlled transmission mirror 230 and the substrate 202.

The substrate 202 of the illumination light unit 200 may include any suitable material or more to materials, e.g., metallic, ceramic, polymeric, etc. One particular example of a polymer substrate is polyimide, such as Kapton-brand polyimide manufactured by Du Pont, Wilmington, Del. The substrate 202 may be flexible or rigid. The substrate 202 may also be formed from a transparent material, such as polycarbonate, for example, as manufactured by GE Plastics, Pittsfield, Mass.

The array of LEDs 210 disposed on substrate 202 includes one or more LEDs 212. Each LED 212 includes one or more light emitting surfaces 214 and is capable of generating illumination light. The array 210 may include any suitable LED or LEDs 212. In this regard, “LED” refers to a diode that emits light, whether visible, ultraviolet, or infrared. It includes incoherent encased or encapsulated semiconductor devices marketed as “LEDs,” whether of the conventional or super radiant variety. If the LED emits non-visible light, such as ultraviolet light, and in some cases where it emits visible light, it is packaged to include a phosphor (or it may illuminate a remotely disposed phosphor) to convert short wavelength light to longer wavelength visible light, in some cases yielding a device that emits white light. An “LED die” is an LED in its most basic form, i.e., in the form of an individual component or chip made by semiconductor processing procedures. The component or chip can include electrical contacts suitable for application of power to energize the device. The individual layers and other functional elements of the component or chip are typically formed on the wafer scale, and the finished wafer can then be diced into individual piece parts to yield a multiplicity of LED dies.

In some embodiments, the illumination light unit 200 continuously emits white light, and the image-forming panel (e.g., image-forming panel 110 of FIG. 1) is combined with a color filter matrix to form groups of multicolored pixels (such as yellow/blue (YB) pixels, red/green/blue (RGB) pixels, red/green/blue/white (RGBW) pixels, red/yellow/green/blue (RYGB) pixels, red/yellow/green/cyan/blue (RYGCB) pixels, or the like) so that the displayed image is polychromatic.

Alternatively, polychromatic images can be displayed using color sequential techniques, where, instead of continuously back-illuminating the image-forming panel with white light and modulating groups of multicolored pixels in the image-forming panel to produce color, separate differently colored light sources within the illumination light unit 200 itself (selected, for example, from red, orange, amber, yellow, green, cyan, blue (including royal blue), and white in combinations such as those mentioned herein) are modulated such that the backlight flashes a spatially uniform colored light output (such as, for example, red, then green, then blue) in rapid repeating succession. This color-modulated backlight is then combined with a display module that has only one pixel array (without any color filter matrix), the pixel array being modulated synchronously with the backlight to produce the whole gamut of achievable colors (given the light sources used in the backlight) over the entire pixel array, provided the modulation is fast enough to yield temporal color-mixing in the visual system of the observer. Examples of color sequential displays, also known as field sequential displays, are described in U.S. Pat. No. 5,337,068 (Stewart et al.) and U.S. Pat. No. 6,762,743 (Yoshihara et al.).

In some cases, it may be desirable to provide only a monochrome display. In those cases the illumination light unit 200 can include filters or specific sources that emit predominantly in one visible wavelength or color.

In some embodiments, one or more LEDs 212 of the array 210 can include two or more LED die or packages. For example, LED 212a can include a red, green, and blue LED die such that the combined light output of the LED 212a is substantially white. Any suitable combination of LEDs may be used to produce white illumination light.

Conductors may be provided on different layers for carrying optical current to and from the LEDs 212. For example, conductors may be provided on the substrate 202. As illustrated in FIG. 2A, conductors 206 are positioned on a first major surface 204 of the substrate 202 to carry current to and/or from the LEDs 212. Electrical connections may be made from the LEDs 212 to electrical conductors using any suitable technique, such as solder reflow, or connection using a conductive epoxy such as Metech type 6144, available from Lord Corp., Cary, N.C.

The substrate 202 may be provided with a thermally conductive layer on its lower surface (not shown) for extracting heat generated by the array of LEDs 210. In addition, the conductors 206 may be provided with large area pads 208 to aid in spreading the heat generated by the LEDs 212.

The LEDs 212 may be arranged on the substrate 202 in a rectangular pattern, or a square pattern as illustrated. This leads to easy display of vertical and horizontal lines in an information display application. A rectangular or square pattern is not required, however, and the LEDs 212 may be laid out on the substrate 202 in some other pattern, e.g., in a hexagonal pattern.

Positioned between the controlled transmission mirror 230 and the array of LEDs 210 is the reflector sheet 220 that includes the array of reflectors 226. Reflectors 227 of the array 226 define individual portions of the reflector sheet 220. Each reflector 227 is operable to direct at least a portion of illumination light from its respective LED 212 to the controlled transmission mirror 230. The reflector sheet 220 includes a first major surface 222, a second major surface 224 that is reflective, and apertures 228. Respective LEDs 212 of the array of LEDs 210 protrude through respective apertures 228 of the reflectors 226. The substrate 202 is positioned adjacent the first major surface 222 of the reflector sheet 220, and light emitting surfaces 214 of the LEDs 212 are positioned adjacent the reflective surface 224 of the reflector sheet 220.

The reflective surface 224, which reflects the light emitted by the LEDs 212, is curved so as to direct the light in a desired direction. For example, the reflective surface 224 may be paraboloidal, elliptical, or any other suitable shape. The reflective surface 224 may be a metalized surface formed on a shaped film, or may be a multilayer reflector, for example, a vacuum coated dielectric reflector or a multilayer polymeric reflector. For example, the reflective surface 224 may be a reflective layer deposited on a reflector sheet base that has a surface with curved regions, and the reflective layer is deposited on the curved regions of the reflector sheet base. In another approach, the reflector sheet 220 itself may be formed of a reflecting material, for example, stamped out of ESR™ available from 3M Co., St. Paul, Minn., using any suitable technique, e.g., those techniques described in U.S. Pat. No. 6,788,463 (Merrill et al.).

In some embodiments, the reflective surface 224 is preferably highly reflective. For example, the reflective surface 224 may have an average reflectivity for visible light emitted by the LEDs 212 of at least 90%, 95%, 98%, or 99% or more. The reflective surface 224 can be a predominantly specular, diffuse, or combination specular/diffuse reflector, whether spatially uniform or patterned. Suitable high reflectivity materials include, without limitation: Vikuiti™ Enhanced Specular Reflector (ESR) multilayer polymeric film available from 3M Company; a film made by laminating a barium sulfate-loaded polyethylene terephthalate film (2 mils thick) to Vikuiti™ ESR film using a 0.4 mil thick isooctylacrylate acrylic acid pressure sensitive adhesive, the resulting laminate film referred to herein as “EDR II” film; E-60 series Lumirror™ polyester film available from Toray Industries, Inc.; porous polytetrafluoroethylene (PTFE) films, such as those available from W. L. Gore & Associates, Inc.; Spectralon™ reflectance material available from Labsphere, Inc.; Miro™ anodized aluminum films (including Miro™ 2 film) available from Alanod Aluminum-Veredlung GmbH & Co.; MCPET high reflectivity foamed sheeting from Furukawa Electric Co., Ltd.; and White Refstar™ films and MT films available from Mitsui Chemicals, Inc.

The space 229 formed above the LED 212 and reflecting surface 224 may be air or may be filled with a transparent material. For example, transparent material may be molded in place over the LED 212 and reflective surface 224.

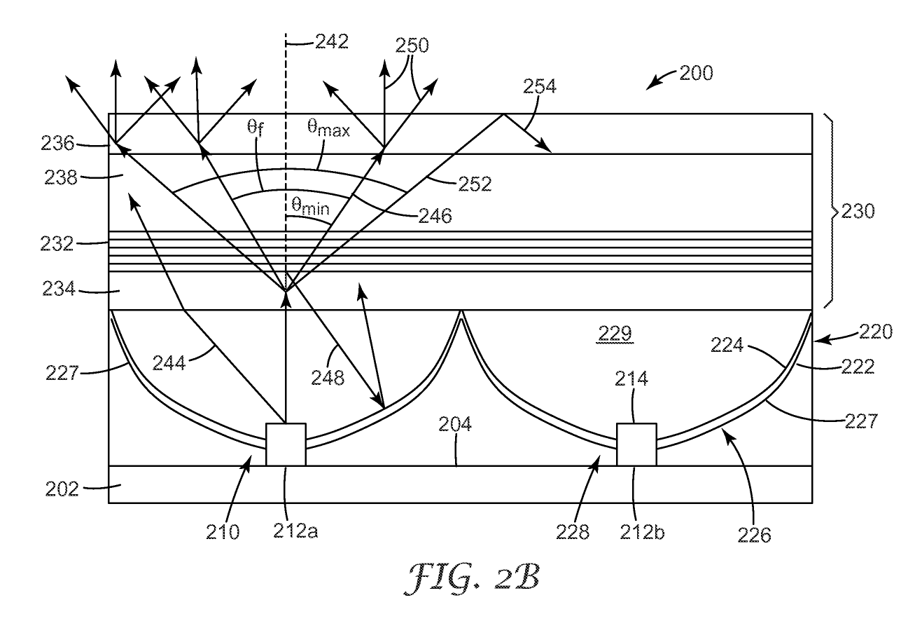

One exemplary embodiment of a reflector sheet 320 is illustrated in FIG. 3. Reflector sheet 320 includes a reflective surface 324 and an array of reflectors 326. Each reflector 327 defines individual portions 329 of the reflector sheet 320. Further, each reflector 327 includes an aperture 328. Each aperture 328 may take any suitable shape such that one or more light emitting surfaces of an LED can provide light into the reflector 326. Each reflector 326 can be separated by a land 321. The land 321 may take any suitable shape or size. In some embodiments, the sheet 320 may be formed such that no land area exists between the reflectors 327, i.e., each reflector 327 shares an edge with one or more adjacent reflectors 327. The reflector sheet 320 may include any suitable material or materials, e.g., those materials described in regard to reflector sheet 220 of FIGS. 2A-B.

Returning to FIGS. 2A-B, the controlled transmission mirror 230 is positioned adjacent the second major surface 224 of the reflector sheet 220. The controlled transmission mirror 230 includes an input coupling element 234, an output coupling element 236, and a first multilayer reflector 232 disposed between the input coupling element 234 and the output coupling element 236. The input coupling element 234 redirects at least some of the illumination light incident thereon in a direction substantially perpendicular to the first multilayer reflector 232 into a direction that is transmitted through the first multilayer reflector 232 to the output coupling element 236. In other words, the controlled transmission mirror 230 reflects some of the light within the reflectors 227 and permits some light to escape from the reflectors 227 after spreading the light laterally from each LED 212. This lateral light spreading aids in making the intensity profile of the light exiting the illumination light unit 200 more uniform, so that the viewer sees a more uniformly illuminated image. In addition, where different LEDs 212 produce light of different colors, the lateral light spreading results in more complete mixing of the different colors. The operation of the controlled transmission mirror 230 is discussed in more detail herein.

Further, the controlled transmission mirror 230 can be positioned any suitable distance from the reflector sheet 220. In some embodiments, the controlled transmission mirror 230 can be placed on the reflector sheet 220; in other embodiments, the controlled transmission mirror 230 can be attached to the reflector sheet 220 using any suitable technique.

The controlled transmission mirror 230 advantageously provides uniform back-illumination for direct-lit displays that use quasi-point light sources, such as LEDs, but may also be used with other types of light sources. The controlled transmission mirror 230 can include a supporting layer 238 that is substantially transparent to the light generated by the LEDs 212a-b. The multilayer reflector 232 is disposed on at least one side of the supporting layer 238. In the illustrated embodiment, the multilayer reflector 232 is disposed on the lower side of the supporting layer 238 facing the LEDs 212. The multilayer reflector 232 may be attached to the supporting layer 238, for example, by lamination, either with or without an adhesive.

The supporting layer 238 may be formed of any suitable transparent material, organic or inorganic, e.g., polymer or glass. Suitable polymer materials may be amorphous or semi-crystalline, and may include homopolymer, copolymer, or blends thereof. Example polymer materials include, but are not limited to, amorphous polymers such as poly(carbonate) (PC); poly(styrene) (PS); acrylates, for example acrylic sheets as supplied under the ACRYLITE® brand by Cyro Industries, Rockaway, N.J.; acrylic copolymers such as isooctyl acrylate/acrylic acid; poly(methylmethacrylate) (PMMA); PMMA copolymers; cycloolefins; cycloolefin copolymers; acrylonitrile butadiene styrene (ABS); styrene acrylonitrile copolymers (SAN); epoxies; poly(vinylcyclohexane); PMMA/poly(vinylfluoride) blends; atactic poly(propylene); poly(phenylene oxide) alloys; styrenic block copolymers; polyimide; polysulfone; poly(vinyl chloride); poly(dimethyl siloxane) (PDMS); polyurethanes; and semicrystalline polymers such as poly(ethylene); poly(propylene); poly(ethylene terephthalate) (PET); poly(carbonate)/aliphatic PET blends; poly(ethylene naphthalate)(PEN); polyamides; ionomers; vinyl acetate/polyethylene copolymers; cellulose acetate; cellulose acetate butyrate; fluoropolymers; poly(styrene)-poly(ethylene) copolymers; PET and PEN copolymers, and clear fiberglass panels. Some of these materials, for example, PET, PEN and copolymers thereof, may be oriented so as to change the material refractive index from that of the isotropic material.

The input coupling element 234 is disposed at the lower side of the multilayer reflector 232, and an output coupling element 236 is disposed at the upper side of the supporting layer 238 such that the multilayer reflector is disposed between the input and output coupling elements 234, 236. The input coupling element 234 and output coupling element 236 are used to change the direction of at least some of the light entering these coupling elements 234, 236, so as to couple light into the controlled transmission mirror 230 or to couple light out of the controlled transmission mirror 230. Exemplary embodiments of input coupling elements 234 and output coupling elements 236 include diffusers, both surface and bulk diffusers, and microreplicated surfaces. Some exemplary embodiments of input coupling elements 234 and output coupling elements 236 are described in greater detail herein. The input coupling element 234 may be the same as the output coupling element 236, e.g., the input and output coupling elements 234, 236 may both be bulk diffusers. Alternatively, the input coupling element 234 may be different from the output coupling element 236. The input and output coupling elements 234, 236 may be laminated or otherwise formed integrally with the supporting layer 238 and the multilayer reflector 232.

The multilayer reflector 232 is generally constructed of optical repeating units that form the basic building blocks of a dielectric stack. The optical repeating units typically include two or more layers of at least a high and a low refractive index material. A multilayer reflector can be designed, using these building blocks, to reflect infrared, visible, or ultraviolet wavelengths and one or both of a given orthogonal pair of polarizations of light. In general, the stack can be constructed to reflect light of a particular wavelength, λ, by controlling the optical thickness of the layers according to the relationship:

λ=(2/M)*Dᵣ,

where M is an integer representing the order of the reflected light, and Dᵣ is the optical thickness of an optical repeating unit. For the first order reflection (M=1), the optical repeating unit has an optical thickness of λ/2. Simple ¼-wave stacks include a number of layers, where each layer has an optical thickness of ¼. Broadband reflectors can include multiple ¼-wave stacks tuned to various wavelengths, a stack with a continuous gradation of the layer thickness throughout the stack, or combinations thereof. A multilayer reflector may further include non-optical layers. For example, a coextruded polymeric dielectric reflector may include protective boundary layers and/or skin layers used to facilitate formation of the reflector film and to protect the reflector. Polymeric optical stacks particularly suited to the present disclosure are described in published PCT Patent Application WO 95/17303, entitled MULTILAYER OPTICAL FILM, and U.S. Pat. No. 6,531,230 (Weber et al.). In other embodiments, the dielectric stack may be a stack of inorganic materials. Some suitable materials used for the low refractive index material include SiO₂, MgF₂, and CaF₂ and the like. Some suitable materials used for the high refractive index material include TiO₂, Ta₂O₅, ZnSe and the like. This disclosure, however, is not limited to quarter-wave stacks and is more generally applicable to any dielectric stack, including, for example, computer optimized stacks and random layer thickness stacks.

Reflection by a dielectric stack of light at a particular wavelength is dependent, in part, on the propagation angle through the stack. The multilayer reflector may be considered to have a reflection band profile (e.g., band center and bandedges) for light propagating in the stack at a particular angle. This band profile changes as the angle of propagation in the stack changes. The propagation angle in the stack is generally a function of the incident angle and the refractive indices of the materials in the stack and the surrounding medium. The wavelength of the bandedge of the reflection band profile changes as the propagation angle in the stack changes. Typically, for the polymeric materials under consideration, the bandedge of the reflector for light at normal incidence shifts to about 80% of its normal incidence value when viewed at grazing incidence in air. This effect is described in greater detail in U.S. Pat. No. 6,208,466 (Liu et al.). The bandedge may shift considerably further when the light is coupled into the reflector using a medium having a refractive index higher than air. Also, the shift in the bandedge is typically greater for p-polarization light than for s-polarization light.

The angular dependence of the reflection band profile (e.g., bandedge shifting with angle) results from a change in the effective layer thickness. The reflection band shifts towards shorter wavelengths as the angle increases from normal incidence. While the total path length through a given layer increases with angle, the change in band position with angle does not depend on the change in the total path length through a layer with angle. Rather, the band position depends on the difference in path length between light rays reflected from the top and bottom surfaces of a given layer. This path difference decreases with angle of incidence as shown by the familiar formula n.d.cosθ, which is used to calculate the wavelength, λ, to which a given layer is tuned as a ¼ wave thick layer, where n is the refractive index of the layer and θ is the propagation angle of the light relative to a normal to the layer.

The above description describes how the bandedge of the reflection band profile changes as a function of angle. As used herein, the term bandedge generally refers to the region where the multilayer reflector changes from substantial reflection to substantial transmission. This region may be fairly sharp and described as a single wavelength. In other cases, the transition between reflection and transmission may be more gradual and may be described in terms of a center wavelength and bandwidth. In either case, however, a substantial difference between reflection and transmission exists on either side of the bandedge.

As light at the particular wavelength propagates in the stack at increasing propagation angles (measured from an axis normal to the interface of the repeating units), the light approaches the bandedge. In one example, at high enough propagation angles, the stack will become substantially transparent to that particular wavelength of light and the light will transmit through the stack. Thus, for a given wavelength of light, the stack has an associated propagation angle below which the stack substantially reflects the light, and another propagation angle above which the stack substantially transmits the light. Accordingly, in certain multilayer stacks, each wavelength of light may be considered as having a corresponding angle below which substantial reflection occurs and a corresponding angle above which substantial transmission occurs. The sharper the bandedge, the closer these two angles are for the associated wavelength. For the purposes of the present description, the approximation is made that these two angles are the same and have a value of θₘᵢₙ.

The above description describes the manner in which monochromatic light in a given stack shifts from reflection to transmission with increasing angle of propagation. If the stack is illuminated with light having a mixture of components at different wavelengths, the angle, θₘᵢₙ, at which the reflective stack changes from being reflective to transmissive is different for the different wavelength components. Since the bandedge moves to shorter wavelengths with increasing angle, the value of θₘᵢₙ is lower for light at longer wavelengths, potentially allowing more light at longer wavelengths to be transmitted through the multilayer reflector than at shorter wavelengths. In some embodiments, it is desired that the color of the light passing out of the controlled transmission mirror be relatively uniform. One approach to balancing the color is to use an input and output coupling element that couples more light at shorter wavelengths than at longer wavelengths into the controlled transmission mirror.

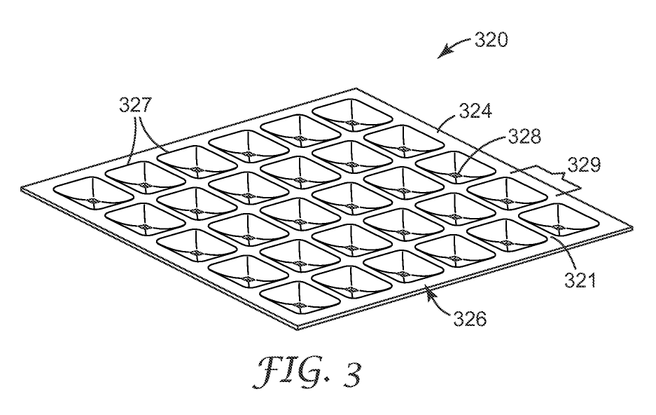

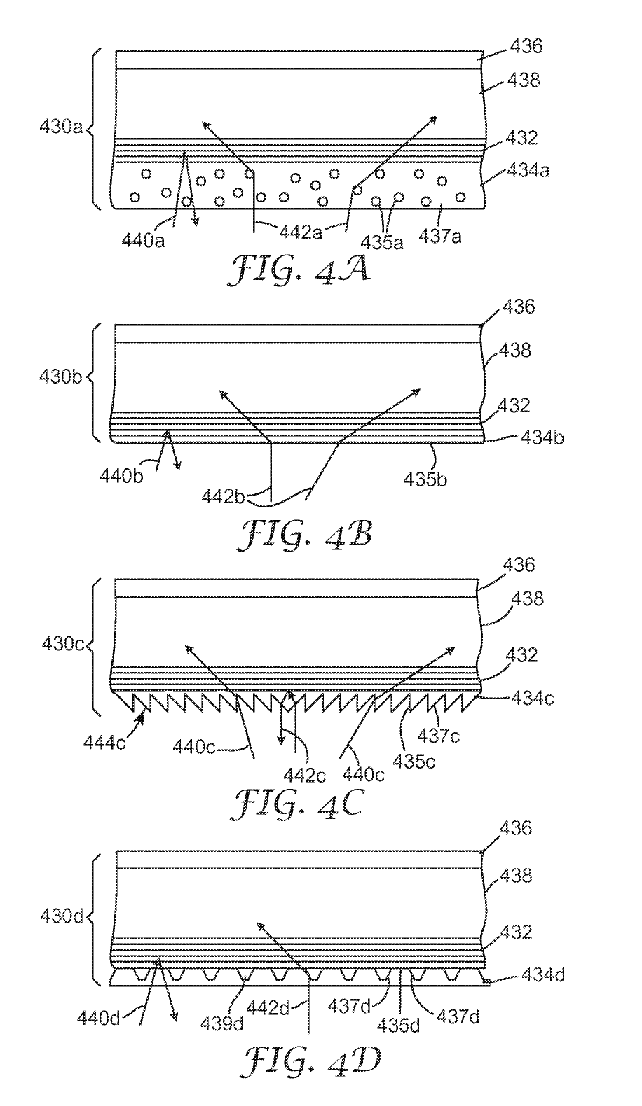

One example of such a coupling element is a bulk diffuser that contains scattering particles dispersed within a polymer matrix, as is discussed herein with regard to FIGS. 4A and 5A. The scattering particles have a refractive index different from the refractive index of the surrounding matrix. The nature of diffusive scattering is that, all else being equal, light at shorter wavelengths is scattered more than light at longer wavelengths.

In addition, the degree of scattering is dependent on the difference between the refractive indices of the particles and the surrounding matrix. If the difference in refractive index is greater at shorter wavelengths, then even more short wavelength light is scattered. In one particular embodiment of a diffusive coupling element, the matrix is formed of biaxially stretched PEN, which has an in-plane refractive index of about 1.75 for red light and about 1.85 for blue light, where the light is s-polarized, i.e., has high dispersion. The in-plane refractive index is the refractive index for light whose electric vector is polarized parallel to the plane of the film. The out-of-plane refractive index, for light polarized parallel to the thickness direction of the film, is about 1.5. The refractive index for p-polarized light is lower than that of the s-polarized light, since the p-polarized light experiences an effective refractive index that is a combination of the in-plane refractive index and the out-of-plane refractive index. The particles in the matrix may have a high refractive index, for example titanium dioxide (TiO₂) particles have a refractive index of about 2.5. The refractive index of TiO₂ varies by approximately 0.25 over the range 450 nm-650 nm, which is greater than the approximately 0.1 refractive index variation for PEN over a similar wavelength range. Thus, the refractive index difference between the particles and the matrix changes by about 0.15 across the visible spectrum, resulting in increased scattering for the blue light. Consequently, the refractive index difference between the particles and the matrix can vary significantly over the visible spectrum.

Thus, due to the wavelength dependence of the diffusive scattering mechanism and the large difference in the refractive index difference over the visible spectrum, the degree to which blue light is scattered into the multilayer reflector is relatively high, which at least partially compensates for the larger value of θₘᵢₙ at shorter wavelengths.

Other embodiments of input and output coupling elements, for example, those described herein with reference to FIGS. 4B-4D and 5B-5D, rely primarily on refractive effects for diverting the light. For example, a coupling element may be provided with a surface structure or holographic features for coupling the light into or out of the multilayer reflector. Normal material dispersion results in greater refractive effects for shorter wavelengths. Therefore, input and output coupling elements that rely on refractive effects may also at least partially compensate for the larger value of θₘᵢₙ, at shorter wavelengths.

With the understanding, therefore, that the light entering the controlled transmission mirror may have a wide variation in the value of θₘᵢₙ, the following description refers to only a single value of θₘᵢₙ, for simplicity.

Another effect that the system designer can use to control the amount of light passing through the multilayer reflector is the selection of a Brewster's angle, i.e., the angle at which p-polarized light passes through the multilayer reflector without reflective loss. For adjacent isotropic layers 1 and 2 in the multilayer reflector, having refractive indices n1 and n2 respectively, the value of Brewster's angle in layer 1, θ_{B}, for light passing from layer 1 to layer 2, is given by the expression tan θ_{B}=n2/n1. Thus, the particular materials employed in the different layers of the multilayer reflector may be selected to provide a desired value of Brewster's angle.

The existence of the Brewster's angle for a multilayer reflector provides another mechanism for allowing light to pass through the reflector other than relying on the input and output coupling layers to divert the light through large angles. As the angle within the controlled transmission mirror is increased for p-polarized light, the reflection band substantially disappears at Brewster's angle. At angles above the Brewster's angle, the reflection band reappears and continues to shift to shorter wavelengths.

In certain embodiments, it may be possible to set the value of θ_{B} for blue light to be less than θₘᵢₙ, but have θ_{B} be greater than θmin for red light. This configuration may lead to an increased transmission for blue light through the multilayer reflector, which compensates at least in part for the higher value of θₘᵢₙ for shorter wavelength light.

In some embodiments, the transmission level of the controlled transmission mirror can be controlled by adjusting the input coupling strength and/or the output coupling strength. For example, in some embodiments, the output coupling element can be made very diffuse, while the input coupling element can be made less diffuse than the output coupling element.

Returning to FIG. 2B, at least some of the light from the LED 212a propagates towards the controlled transmission mirror 230. A portion of the light, exemplified by light ray 244, passes through the input coupling element 234 and is incident on the multilayer reflector 232 at an angle greater than θₘᵢₙ and is transmitted into the support layer 238. Angles are described herein as the angle relative to a normal 242 to the multilayer reflector 232. Another portion of the light, exemplified by light ray 246, is incident at the input coupling element 234 at an angle less than θₘᵢₙ, but is diverted by the input coupling element 234 to an angle of at least θₘᵢₙ, and is transmitted through the multilayer reflector 232 into the support layer 238. Another portion of light from the LED 212a, exemplified by light ray 248, passes through the input coupling element 234 and is incident at the multilayer reflector 232 at an angle that is less than θₘᵢₙ. Consequently, light 248 is reflected by the multilayer reflector 232. The value of θₘᵢₙ is determined by how far the bandedge of the multilayer reflector 232 shifts before light at the wavelength emitted by the LED 212a is transmitted through the multilayer reflector 232.

In some embodiments, it is desired that the multilayer reflector 232 is attached to the support layer 238 in a manner that avoids a layer of air, or some other material of a relatively low refractive index, between the multilayer reflector 232 and support layer 238. Such close optical coupling between the support layer 238 and the multilayer reflector 232 reduces the possibility of total internal reflection of light at the multilayer reflector 232 before reaching the support layer 238.

The maximum angle of the light within the support layer 238, θₘₐₓ, is determined by the relative refractive indices of the input coupling element 234, nᵢ, and the support layer 238, nₛ. Where the input coupling element 234 is a surface coupling element, the value of nᵢ is equal to the refractive index of the material on which the surface is formed. Propagation from the input coupling element 234 into the support layer 238 is subject to Snell's law. If the light is assumed to be incident at the interface between the input coupling element 234 and the support layer 238 at grazing incidence, close to 90°, then the value of θₘₐₓ is given by the expression:

θₘₐₓ=sin⁻¹(n/nₛ).

Thus, the light can propagate along the support layer 238 in a direction of θ=90° where the value of nₛ is equal to that of nᵢ, or less. Higher values of θₘₐₓ may lead to increased lateral spreading of the light, and thus to increased brightness uniformity.

The output coupling element 236 is used to extract at least some of the light out of the controlled transmission mirror 230. For example, some of light 246 may be diffused by the output coupling element 236 so as to pass out of the controlled transmission mirror 230 as light 250.

Other portions of the light within the substrate, for example ray 252, may not be diverted by the output coupling element 236. If light 252 is incident at the upper surface of the output coupling element 236 at an angle greater than the critical angle of the output coupling element, θ_{c}=sin⁻¹ (1/nₑ), where nₑ is the refractive index of the output coupling element, then the light 252 is totally internally reflected within the output coupling element 236 and redirected towards the support layer 238 as light 254. The reflected light 224 may subsequently be totally internally reflected at the lower surface of the input coupling element 234. Alternatively, the light 254 may subsequently be diverted by the input coupling element 234 and pass out of the controlled transmission mirror 230 towards reflector sheet 220.

If the light that passes into the support layer 238 with an angle of at least θₘᵢₙ is incident at the output coupling element 236 with an angle greater than θ_{c}, then that light which is not diverted out of the output coupling element 236 is typically totally internally reflected within the output coupling element 236. If, however, the light that passes into the support layer 238 with an angle of θₘᵢₙ reaches the output coupling element 236 at a propagation angle less than θ_{c} then a fraction of that light may be transmitted out through the output coupling element 236, even without being diverted by the output coupling element 236, subject to Fresnel reflection loss at the interface between the output coupling element 236 and the air. Thus, there are many possibilities for the light to suffer multiple reflections and for its direction to be diverted within the illumination light unit 200. The light may also propagate transversely within the support layer 238 and/or within the space between the controlled transmission mirror 230 and the reflector sheet 220. These multiple effects combine to increase the likelihood that the light is spread laterally and extracted to produce a backlight illuminance of more uniform brightness.

Except for the possibility that the multilayer reflector 230 has a Brewster's angle, θ_{B}, that is lower than θₘᵢₙ, there is a forbidden angular region, θ_{f}, for light originating at the LED 212a. This forbidden angular region, θ_{f} has a half-angle of θₘᵢₙ, and is located above the LED 212a. Light cannot pass through the multilayer reflector 232 within the forbidden angular region.

In view of the description of the controlled transmission mirror 230 provided above, it can be seen that the function of the input coupling element 234 is to divert at least some light, which would otherwise be incident at the multilayer reflector 232 at an angle less than θₘᵢₙ, so as to be incident at the multilayer reflector 232 at an angle of at least θₘᵢₙ. Also, the function of the output coupling element 236 is to divert at least some light, which would otherwise be totally internally reflected within the controlled transmission mirror 230, so as to pass out of the controlled transmission mirror 230.

The controlled transmission mirror 230 may optionally be provided with two multilayer reflectors positioned on either side of the support layer 238. The multilayer reflectors can have the same value of θₘᵢₙ, although this is not required. The controlled transmission mirror may also have a single multilayer reflector positioned on the side of the support layer 238 away from the LEDs 210 while remaining effective at controlling the angular range of light that propagates within the controlled transmission mirror 230.

In embodiments where the illumination light unit is used in a display or projection system, the output of individual LEDs or groups of LEDs can be selectively controlled, thereby producing controlled light output spatial distributions at the output of the illumination light unit. For example, the output of an illumination light unit (e.g., illumination light unit 200 of FIG. 2A-B) may be imaged onto image-forming panel (e.g., image-forming panel 110 of FIG. 1), and the resulting image is directed to a viewer as is described, e.g., in PCT Patent Publication No. WO 03/077013 A2 (Whitehead et al.) and U.S. patent application Ser. No. 10/739,792 (Ouderkirk et al.). The contrast ratio of the viewed image can be increased by modifying the spatial distribution of light produced by the illumination light unit. As used herein, the term “contrast ratio” refers to the ratio of intensity of the highest luminance regions of an image and the lowest luminance regions of the same image. For example, regions of a display that should be relatively dark can be obtained by having both the illumination light unit and the image-forming panel be in a relatively dark state. Alternatively, very bright regions can be created in the final display by having high brightness at a region of the illumination light unit and the corresponding image-forming panel.

Any suitable technique may be utilized for controlling the illumination light unit and the image-forming panel to achieve increased contrast. For example, image data specifying a desired image is supplied to the controller (e.g., controller 120 of FIG. 1). The image data indicates a desired luminance for an image area corresponding to each of the controllable elements of the image-forming panel. The controller may set each light source of the illumination light unit to provide an approximation of the desired image using a first set of image data derived from the original image data. This could be accomplished, for example, by determining an average or weighted average of the desired luminance values for the image areas corresponding to each light source of the lower-resolution illumination light unit.

The controller may then set the controllable elements of the image-forming panel to cause the resulting image to approach the desired image using a second set of image data derived from the original image data. This could be done, for example, by dividing the desired luminance values by the intensity of light incident from the illumination light unit on the corresponding controllable elements of the image-forming panel. The intensity of light incident from the illumination light unit on a controllable element of the image-forming panel can be computed from the known way that light from each light source of the illumination light unit is distributed on the image-forming panel. The contributions from one or more of the light sources can be summed to determine the intensity with which any controllable element of the higher resolution image-forming panel will be illuminated for the way in which the light sources of the illumination light unit are set. In some embodiments, the second set of image data is higher in resolution than the first set of image data.

Exemplary embodiments of different types of input coupling elements are now discussed with reference to FIGS. 4A-4D. In these embodiments, a multilayer reflector 432 is positioned between the support layer 438 and the input coupling element 434. In other exemplary embodiments, not illustrated, the support layer may lie between the input coupling element and the multilayer reflector. In other embodiments, the controlled transmission mirror may not include a support layer, and the input coupling element and the output coupling element can be positioned on opposite surfaces of the multilayer reflector.

In FIG. 4A, an exemplary embodiment of a controlled transmission mirror 430a includes an input coupling element 434a, a multilayer reflector 432, a support layer 438 and an output coupling element 436. In this particular embodiment, the input coupling element 434a is a bulk diffusing layer that includes diffusing particles 435a dispersed within a transparent matrix 437a. At least some of the light entering the input coupling element 434a at an angle less than θₘᵢₙ, for example light rays 442a, is scattered within the input coupling element 434a at an angle greater than θₘᵢₙ and is consequently transmitted through the multilayer reflector 432. Some light, for example, ray 440a, may not be scattered within the input coupling element 434a through a sufficient angle to pass through the multilayer reflector 432, and instead is reflected by the multilayer reflector 432. Suitable materials for the transparent matrix 437a include, but are not limited to, polymers such as those listed herein as being suitable for use in a substrate.

The diffusing particles 435a may be any type of particle useful for diffusing light, for example, transparent particles whose refractive index is different from the surrounding polymer matrix 437a, diffusely reflective particles, or voids or bubbles in the matrix 437a. Examples of suitable transparent particles include solid or hollow inorganic particles, for example, glass beads or glass shells, and solid or hollow polymeric particles, for example, solid polymeric spheres or polymeric hollow shells. Examples of suitable diffusely reflecting particles include particles of titanium dioxide (TiO₂), calcium carbonate (CaCO₃), barium sulphate (BaSO₄), magnesium sulphate (MgSO₄) and the like. In addition, voids in the matrix 437a may be used for diffusing the light. Such voids may be filled with a gas, for example, air or carbon dioxide.

Another exemplary embodiment of a controlled transmission mirror 430b is schematically illustrated in FIG. 4B, in which the input coupling element 434b includes a surface diffuser 435b. The surface diffuser 435b may be provided on the bottom layer of the multilayer reflector 432 or on a separate layer attached to the multilayer reflector 432. The surface diffuser 435b may be molded, impressed, cast, or otherwise prepared.

At least some of the light incident at the input coupling element 434b, for example, light rays 442b, is scattered by the surface diffuser 435b to propagate at an angle greater than θₘᵢₙ, and is consequently transmitted through the multilayer reflector 432. Some light, for example ray 440b, may not be scattered by the surface diffuser 435b through a sufficient angle to pass through the multilayer reflector 432 and is instead reflected.

Another exemplary embodiment of a controlled transmission mirror 430c is schematically illustrated in FIG. 4C, in which the input coupling element 434c includes a microreplicated structure 444c having facets 435c and 437c. The structure 444c may be provided on the bottom layer of the multilayer reflector 432 or on a separate layer attached to the multilayer reflector 432. The structure 444c is different from the surface diffuser 435b of FIG. 4B in that the surface diffuser 435b includes a mostly random surface structure, whereas the structure 444c includes more regular structures with the defined facets 435c, 437c.

At least some of the light incident at the input coupling element 434c, for example, rays 440c incident on facets 435c, would not reach the multilayer reflector 432 at an angle of θₘᵢₙ but for refraction at the facet 435c. Accordingly, light rays 440c are transmitted through the multilayer reflector 432. Some light, for example ray 442c, is refracted by facet 437c to an angle less than θₘᵢₙ, and is, therefore, reflected by the multilayer reflector 432.

Another exemplary embodiment of a controlled transmission mirror 430d is schematically illustrated in FIG. 4D, in which the input coupling element 434d has surface portions 435d in optical contact with the multilayer reflector 432 and other surface portions 437d that do not make optical contact with the multilayer reflector 432, with a gap 439d being formed between the element 434d and the multilayer reflector 432. The presence of the gap 439d provides for total internal reflection (TIR) of some of the incident light. This type of coupling element may be referred to as a TIR input coupling element.

At least some of the light incident at the input coupling element 434d, for example, ray 442d incident on the non-contacting surface portions 437d would not reach the multilayer reflector 432 at an angle of θₘᵢₙ but for internal reflection at the surface 437d. Accordingly, light ray 442d may be transmitted through the multilayer reflector 432. Some light, for example ray 440d, may be transmitted through the contacting surface portion 435d to the multilayer reflector 432. This light is incident at the multilayer reflector 432 at an angle less than θₘᵢₙ, and so is reflected by the multilayer reflector 432.

Other types of TIR input coupling elements are described in greater detail in U.S. Pat. No. 5,995,690 (Kotz et al.).

Other types of input coupling elements may be used in addition to those described in detail here, for example, input coupling elements that include a surface or a volume hologram. Also, an input coupling element may combine different approaches for diverting light. For example, an input coupling element may combine a surface treatment, such as a surface structure, surface scattering pattern or surface hologram, with bulk diffusing particles.

It may be desired in some embodiments for the refractive index of the input coupling element and output coupling element to each have a relatively high refractive index, for example, comparable to or higher than the average refractive index (the average of the refractive indices of the high index and low index layers) of the multilayer reflector. A higher refractive index for the input and output coupling elements helps to increase the angle at which light may propagate through the multilayer reflector, which leads to a greater bandedge shift. This, in turn, may increase the amount of short wavelength light that passes through the controlled transmission mirror, thus making the color of the backlight illumination more uniform. Examples of suitable high refractive index polymer materials that may be used for input and output coupling elements include biaxially stretched PEN and PET that, depending on the amount of stretch, can have in-plane refractive index values of 1.75 and 1.65 respectively for a wavelength of 633 nm.

Commensurate with the choice of materials for the input and output coupling elements, the support layer should be chosen to have an index that does not cause TIR that would block prohibitive amounts of light entering or exiting at large angles. Conversely, a low index for the support layer would result in high angles of propagation in the support layer after injection from an input coupling element having a higher index than the support layer. These two effects can be chosen to optimize the performance of the system with respect to color balance and lateral spreading of the light.

Approaches similar to those described herein for the input coupling element may be used for the output coupling element. For example, a controlled transmission mirror 530a is schematically illustrated in FIG. 5A as having an input coupling element 534, a multilayer reflector 532, a support layer 538, and an output coupling element 536a. In this particular embodiment, the output coupling element 536a is a bulk diffusing layer that includes diffusing particles 537a dispersed within a transparent matrix 539a. Suitable materials for use as the diffusing particles 537a and the matrix 539a are discussed herein for the input coupling element 434a of FIG. 4A.

At least some of the light entering the output coupling element 536a from the support layer 538, for example, light ray 542a, may be scattered by the diffusing particles 537a in the output coupling element 536a and consequently transmitted out of the output coupling element 536a. Some light, for example ray 540a, may not be scattered within the output coupling element 536a and is incident at the top surface of the output coupling element 536a at an incident angle of θ. If the value of θ is equal to or greater than the critical angle, θ_{c}, for the material of the matrix 539a, then the light 540a is totally internally reflected at the surface, as illustrated.

Another exemplary embodiment of controlled transmission mirror 530b is schematically illustrated in FIG. 5B, in which the output coupling element 536b includes a surface diffuser 537b. The surface diffuser 537b may be provided on the upper surface of the support layer 538, as illustrated, or on a separate layer attached to the support layer 538.

Some light propagating within the support layer 538, for example, light 542b, is incident at the surface diffuser 537b and is scattered out of the controlled transmission mirror 530b. Some other light, for example light 540b, may not be scattered by the surface diffuser 537b. Depending on the angle of incidence at the surface diffuser 537b, the light 540b may be totally internally reflected, as illustrated, or some light may be transmitted out of the controlled transmission mirror 530b while some light is reflected back within the support layer 538.

Another exemplary embodiment of controlled transmission mirror 530c is schematically illustrated in FIG. 5C, in which the output coupling element 536c includes a microreplicated structure 535c having facets 537c and 539c. The structure 535c may be provided on a separate layer attached to the support layer 538, as illustrated, or integral with the top surface of the support layer 538 itself. The structure 535c is different than the surface diffuser 537b in that the surface diffuser 537b includes a mostly random surface structure, whereas the structure 535c includes more regular structures with the defined facets 537c, 539c.

Some light propagating within the support layer 538, for example light 542c, is incident at the surface diffuser structure 535c and is refracted out of the controlled transmission mirror 530c. Some other light, for example light 540c, may not be refracted out of the controlled transmission mirror 530c by the structure 535c, but may be returned to the support layer 538. The particular range of propagation angles for light to escape from the controlled transmission mirror 530c is dependent on a number of factors, including at least the refractive indices of the different layers that make up the controlled transmission mirror 530c and the shape of the structure 535c.

Another exemplary embodiment of a controlled transmission mirror 530d is schematically illustrated in FIG. 5D, in which the output coupling element 536d has surface portions 537d in optical contact with the support layer 538 and other surface portions 535d that do not make optical contact with the support layer 538, forming a gap 539d between the output coupling element 536d and the support layer 538. The output coupling element 236d can be any suitable optical element, e.g., light coupling tape. In some embodiments, the output coupling element 536d can include one or more compound parabolic concentrators (CPCs) or other non-imaging concentrators that are in contact with the support layer 538 and that collimate at least a portion of the light that is coupled out of the support layer 538.

At least some of the light incident at the output coupling element 536d, for example, light ray 540d, is incident at a portion of the support layer's surface that is not contacted to the output coupling element 536d, but is adjacent to a gap 539d, and so the light 540d is totally internally reflected within the support layer 538. Some light, for example, ray 542d, may be transmitted through the contacting surface portion 537d, and be totally internally reflected at the non-contacting surface portion 535d, and, therefore, is coupled out of the controlled transmission mirror 530d.

Other types of output coupling elements may be used in addition to those described in detail here. Also, an output coupling element may combine different approaches for diverting light out of the controlled transmission mirror. For example, an output coupling element may combine a surface treatment, such as a surface structure or surface scattering pattern, with bulk diffusing particles.

In some embodiments, the output coupling element may be constructed so that the degree to which light is extracted is uniform across the output coupling element. In other embodiments, the output coupling element may be constructed so that the degree to which light is extracted out of the controlled transmission mirror is not uniform across the output coupling element. For example, in the embodiment of output coupling element 530a illustrated in FIG. 5A, the density of diffusing particles 537a may be varied across the output coupling element 536a so that a higher fraction of light can be extracted from some portions of the output coupling element 536a than others. In the illustrated embodiment, the density of diffusing particles 537a is greater at the left side of the output coupling element 530a. Likewise, the output coupling elements 530b-d, illustrated in FIGS. 5B-5D, may be designed and shaped so that a greater fraction of light can be extracted from some portions of the output coupling elements 536b-d than from other portions. The provision of non-uniformity in the extraction of the light from the controlled transmission mirror, for example extracting a smaller fraction of light from portions of the controlled transmission mirror that contain more light and extracting a greater fraction of light from portions of the controlled transmission mirror that contain less light, may result in a more uniform brightness profile in the illumination light propagating towards the LC panel.

The number of bounces made by light within the controlled transmission mirror, and, therefore, the uniformity of the extracted light, may be affected by the reflectivity of both the input coupling element and the output coupling element. The trade-off for uniformity is brightness loss caused by absorption in the input coupling element, the multilayer reflector, and the output coupling element. This absorption loss may be reduced by proper choice of materials and material processing conditions.

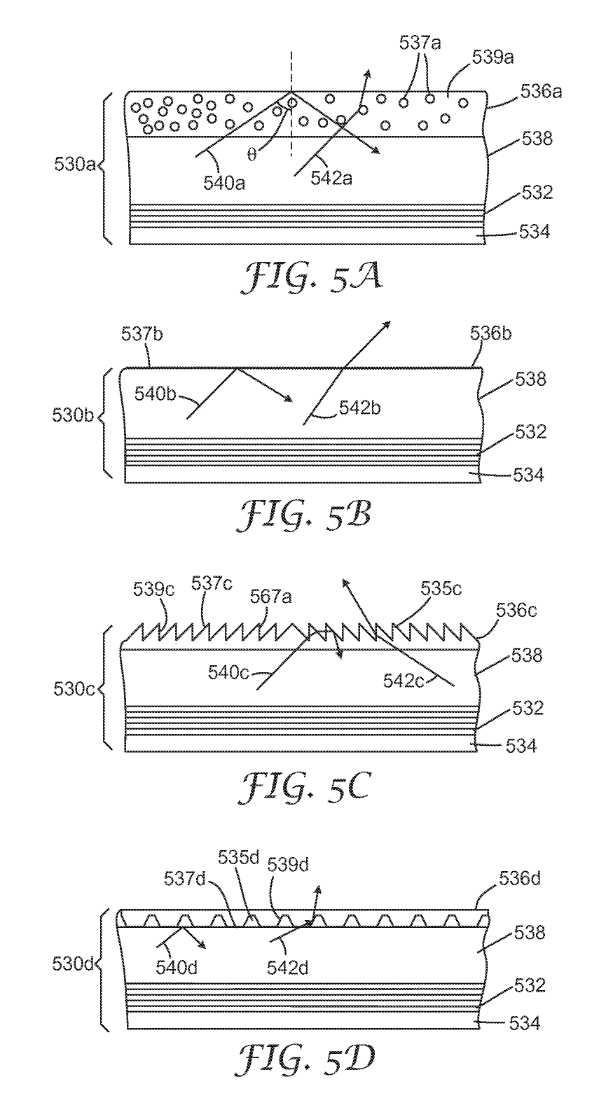

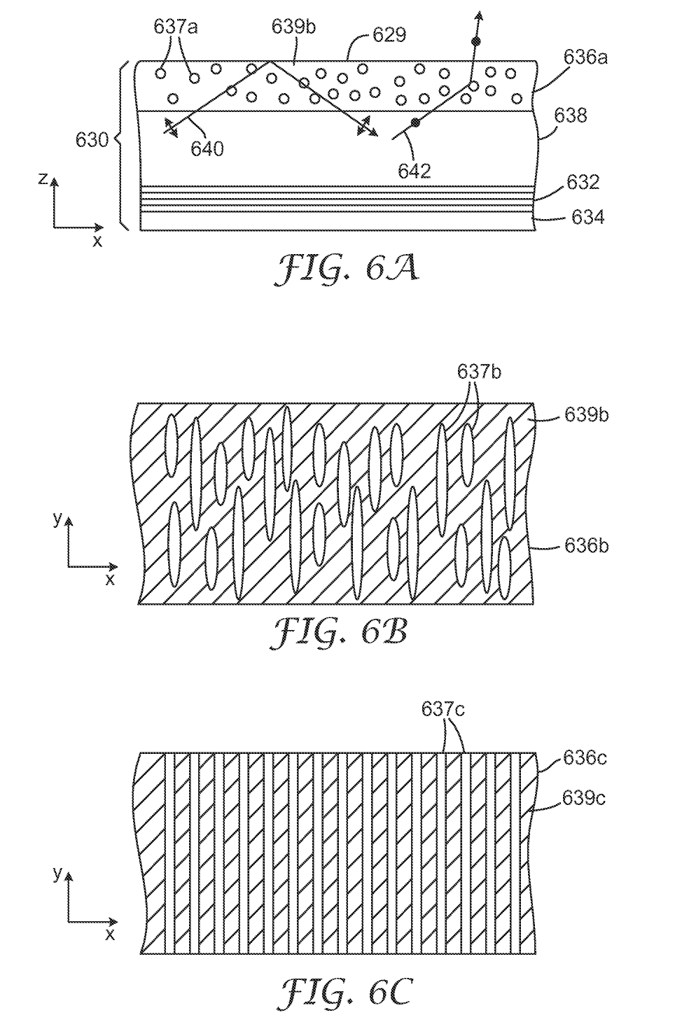

In some exemplary embodiments, the controlled transmission mirror may be polarization sensitive so that light in one polarization state is preferentially extracted from the mixing cavity. A cross-section through one exemplary embodiment of a polarization sensitive controlled transmission mirror 630 is schematically illustrated in FIG. 6A. The controlled transmission mirror 630 includes a support layer 638, a multilayer reflector 632, an input coupling element 634, and a polarization sensitive output coupling element 636a. A three-dimensional coordinate system is used here to clarify the following description. The axes of the coordinate system have been arbitrarily assigned so that the controlled transmission mirror 630 lies parallel to the x-y plane, with the z-axis having a direction through the thickness of the controlled transmission mirror 630. The lateral dimension shown in FIG. 6A is parallel to the x-axis, and the y-direction extends in a direction perpendicular to the drawing.

In some embodiments, the extraction of only one polarization of the light propagating within the support layer 638 is effected by the output coupling element 636a containing two materials, for example, different polymer phases, at least one of which is birefringent. In the illustrated exemplary embodiment, the output coupling element 636a has scattering elements 637a, formed of a first material, embedded within a continuous matrix 639a formed of a second material. The refractive indices for the two materials are substantially matched for light in one polarization state and remain unmatched for light in an orthogonal polarization state. Either or both of the scattering elements 637a and the matrix 639a may be birefringent.

If, for example, the refractive indices are substantially matched for light polarized in the x-z plane, and the refractive indices of the first and second materials are n₁ and n₂ respectively, then we have the condition n₁ₓ≈n_{1z}≈n₂ₓ≈n_{2z} holds, where the subscripts x and z denote the refractive indices for light polarized parallel to the x and z axes respectively. If n_{1y}≠n_{2y}, then light polarized parallel to the y-axis, for example light 642, may be scattered within the output coupling element 636a and pass out of the controlled transmission mirror 630. The orthogonally polarized light, for example, light ray 640, polarized in the x-z plane, remains substantially unscattered on passing within the output coupling element 630 because the refractive indices for this polarization state are matched. Consequently, if the light 640 is incident on the top surface 635 of the output coupling element 636a at an angle equal to, or greater than, the critical angle, θ_{c}, of the continuous phase 639a, the light 640 is totally internally reflected at a surface 635a of the output coupling element 636a.

To ensure that the light extracted from the output coupling element 636a is well polarized, the matched refractive indices are preferably matched to within at least ±0.05, and more preferably matched to within ±0.01. This reduces the amount of scatter for one polarization. The amount by which the light in the y-polarization is scattered is dependent on a number of factors, including the magnitude of the index mismatch, the ratio of one material phase to the other, and the domain size of the disperse phase. Preferred ranges for increasing the amount by which the y-polarized light is forward scattered within the output coupling element 636a include a refractive index difference of at least about 0.05, a particle size in the range of about 0.5 mm to about 20 mm, and a particle loading of up to about 10% or more.

Different arrangements of a polarization-sensitive output coupling element are available. For example, in the embodiment of output coupling element 636b, schematically illustrated in FIG. 6B, the scattering elements 637b constitute a disperse phase of polymeric particles within a continuous matrix 639b. Note that this figure shows a cross-sectional view of the output coupling element 636b in the x-y plane. The birefringent polymer material of the scattering elements 637b and/or the matrix 639b is oriented, for example, by stretching in one or more directions. Disperse phase/continuous phase polarizing elements are described in greater detail in co-owned U.S. Pat. No. 5,825,543 (Ouderkirk et al.) and U.S. Pat. No. 6,590,705 (Allen et al.).

Another embodiment of output coupling element 636c is schematically illustrated in cross-section in FIG. 6C. In this embodiment, the scattering elements 637c are provided in the form of fibers, for example, polymer fibers or glass fibers, in a matrix 639c. The fibers 637c may be isotropic while the matrix 639c is birefringent, or the fibers 637c may be birefringent while the matrix 639c is isotropic, or the fibers 637c and the matrix 639c may both be birefringent. The scattering of light in the fiber-based, polarization sensitive output coupling element 636c is dependent, at least in part, on the size and shape of the fibers 637c, the volume fraction of the fibers 637c, the thickness of the output coupling element 636c, and the degree of orientation, which affects the amount of birefringence. Different types of fibers may be provided as the scattering elements 637c. One suitable type of fiber 637c is a simple polymer fiber formed of one type of polymer material that may be isotropic or birefringent. Examples of this type of fiber disposed in a matrix are described in greater detail in U.S. patent application Ser. No. 11/068,159 (Attorney Docket No. 60401US002). Another example of polymer fiber that may be suitable for use in the output coupling element 636c is a composite polymer fiber, which, in one embodiment, includes a number of scattering fibers formed of one polymer material are disposed in a filler of another polymer material, forming a so-called “islands-in-the-sea” structure. Either or both of the scattering fibers and the filler may be birefringent. The scattering fibers may be formed of a single polymer material or formed with two or more polymer materials, for example a disperse phase in a continuous phase. Composite fibers are described in greater detail in U.S. patent application Ser. No. 11/068,158 (Attorney Docket No. 60371US002), and U.S. patent application Ser. No. 11/068,157 (58959US002).

It will be appreciated that the input coupling element may also be polarization sensitive. For example, where unpolarized light is incident on the controlled transmission mirror, a polarization-sensitive scattering input coupling element may be used to scatter light of one polarization state into the controlled transmission mirror, thereby allowing the light in the orthogonal polarization state to be reflected by the multilayer reflector back to the base reflector. The polarization of the reflected light may then be mixed before returning to the controlled transmission mirror. Thus, the input coupling element may permit light in substantially only one polarization state to enter the controlled transmission mirror. If the different layers of the controlled transmission mirror maintain the polarization of the light, then substantially only one polarization of light may be extracted from the controlled transmission mirror, even if a non-polarization-sensitive output coupling element is used. Both the input and output coupling elements may be polarization sensitive. In some embodiments, a birefringent plate, e.g., quarter-wave film, can be positioned between the output coupling element and the support layer to increase the extraction efficiency of the output coupling element by rotating the polarization of light that is not scattered by the polarization sensitive output coupling element. For polarization sensitive input coupling elements, the birefringent plate may be placed between the input coupling element and the light sources. Any of the polarization sensitive layers used as an output coupling element may also be used as an input coupling element.

All references and publications cited herein are expressly incorporated herein by reference in their entirety into this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An illumination light unit, comprising:
an array of LEDs disposed on a substrate, wherein each LED of the array of LEDs is capable of generating illumination light;
a controlled transmission mirror positioned to receive illumination light from the array of LEDs, wherein the controlled transmission mirror comprises an input coupling element, an output coupling element, and a first multilayer reflector disposed between the input and output coupling elements, wherein the input coupling element redirects at least some of the illumination light incident thereon in a direction substantially perpendicular to the first multilayer reflector into a direction that is transmitted through the first multilayer reflector to the output coupling element; and
a reflector sheet positioned between the substrate and the controlled transmission mirror, wherein the reflector sheet comprises an array of reflectors each having an aperture, wherein respective LEDs of the array of LEDs protrude through respective apertures of the reflectors, and further wherein each reflector is operable to direct at least a portion of illumination light from its respective LED to the controlled transmission mirror.

2. The unit of claim 1, wherein the reflector sheet comprises a reflector sheet base having a surface with curved regions, and a reflective layer disposed on the curved regions of the reflector sheet base.

3. The unit of claim 2, wherein the reflective layer comprises multiple polymer layers of alternating refractive index.

4. The unit of claim 1, wherein the reflectors are curved with a generally paraboloidal curve.

5. The unit of claim 1, wherein the substrate comprises conductors for carrying electrical current between the LEDs and a power source.

6. The unit of claim 5, wherein at least some of the LEDs of the array of LEDs are provided on the substrate as LED dies.

7. The unit of claim 1, wherein the first multilayer reflector comprises a polymeric multilayer film.

8. The unit of claim 1, wherein the input coupling element comprises at least one of a bulk diffuser, a surface diffuser, a structured surface, and a totally internally reflecting input coupler.

9. The unit of claim 1, wherein the output coupling element comprises at least one of a bulk diffuser, a surface diffuser, a structured surface, and a totally internally reflecting output coupler.

10. The unit of claim 1, wherein the controlled transmission mirror further comprises a support layer disposed between the input coupling element and the output coupling element.

11. The unit of claim 10, wherein the support layer is disposed between the first multilayer reflector and the output coupling element.

12. The unit of claim 10, wherein the controlled transmission mirror further comprises a second multilayer reflector disposed between the input and output coupling elements, wherein the support layer is positioned between the first and second multilayer reflectors.

13. The unit of claim 1, wherein the output coupling element couples light out of the controlled transmission mirror in substantially only one polarization state.

14. The unit of claim 1, wherein at least one reflector of the array of reflectors is associated with a red, green, and blue LED.

15. The unit of claim 1, wherein at least one reflector of the array of reflectors is associated with a red, green, blue, and cyan LED.

16. An information display comprising the illumination light unit of claim 1.

17. An optical system, comprising:
an image-forming panel having an illumination side and a viewing side;
an illumination light unit positioned adjacent the illumination side of the image-forming panel, the illumination light unit comprising:
an array of LEDs disposed on a substrate, wherein each LED of the array of LEDs is capable of generating illumination light;
a controlled transmission mirror positioned to receive illumination light from the array of LEDs, wherein the controlled transmission mirror comprises an input coupling element, an output coupling element, and a first multilayer reflector disposed between the input and output coupling elements, wherein the input coupling element redirects at least some of the illumination light incident thereon in a direction substantially perpendicular to the first multilayer reflector into a direction that is transmitted through the first multilayer reflector to the output coupling element; and
a reflector sheet positioned between the substrate and the controlled transmission mirror, wherein the reflector sheet comprises an array of reflectors each having an aperture, wherein respective LEDs of the array of LEDs protrude through respective apertures of the reflectors, and further wherein each reflector is operable to direct at least a portion of illumination light from its respective LED to the controlled transmission mirror.

18. The system of claim 17, wherein the image-forming panel comprises a liquid crystal display (LCD) panel, wherein the system further comprises a first polarizer disposed on the viewing side of the LCD panel and a second polarizer disposed on the illumination side of the LCD panel.

19. The system of claim 17, further comprising a controller coupled to the image-forming panel to control an image displayed by the image-forming panel.

20. The system of claim 19, wherein the controller is also coupled to the illumination light unit, wherein the controller is operable to deliver image data to both the image-forming panel and the illumination light unit.

21. The system of claim 20, wherein the controller is operable to deliver a first set of image data to the illumination light unit and a second set of image data to the image-forming panel, wherein the second set of image data is higher in resolution than the first set of image data.

22. The system of claim 17, wherein at least one reflector of the array of reflectors is associated with a red, green, and blue LED.

23. The unit of claim 17, further comprising one or more light management films disposed between the controlled transmission mirror and the image-forming panel.

24. The unit of claim 23, wherein the one or more light management films comprises at least one of a reflective polarizer and a brightness enhancing film.

25. The system of claim 17, wherein each LED of the array of LEDs is independently controllable.
